(19) United States
(12) Patent Application Publication
(10) Pub. No.: US 2007/0118750 A1
(43) Pub. Date: May 24, 2007

(54) Authenticating a caller initiating a communication session

(75) Inventors: Brad R. Owen, Mesa, AZ (US); Jason Steiner, Glendale, AZ (US)

Correspondence Address: GO DADDY GROUP, INC., 14455 NORTH HAYDEN ROAD, SUITE 219, SCOTTSDALE, AZ, 85260, US

(73) Assignee: The Go Daddy Group, Inc.

(21) Appl. No.: 11/260,920

(22) Filed: Oct. 27, 2005

(51) Int. Cl. H04L 9/00

(52) U.S. Cl. 713/176

(57) ABSTRACT

The invention is a method to authenticate a caller initiating a communication session (such as a VoIP or IM communication session) and accept, reject, or accept and route the communication session accordingly. The caller's terminal adapter or message server (such as a VoIP or IM server) may create a digital signature using the caller's private key and add the digital signature to a header block used to initiate the communication session. The digital signature in the header block may be decrypted by the receiver's terminal adapter or message server using the caller's public key, preferably found in a DNS record. An authenticated digital signature indicates that the header block was sent from the caller identified in the header block. Once the identity of the caller has been authenticated and the communication session accepted, further filtering and routing of the communication session may be performed as desired.

### CROSS REFERENCE TO RELATED PATENT APPLICATION

This patent application is related to the following patent application concurrently filed herewith and also assigned to The Go Daddy Group, Inc.

U.S. patent application Ser. No. ______, “Authenticating a Caller Initiating a Communication Session”.

### FIELD OF THE INVENTION

The invention relates to improved methods for authenticating a caller who is initiating a communication session and is preferably a method to authenticate a caller using Session Initiation Protocol (SIP) to initiate a communication session to a receiver of a Voice over Internet Protocol (VOIP) message or an Instant Message (IM).

### BACKGROUND OF THE INVENTION

The Internet is a worldwide computer network arranged to allow the easy and robust exchange of information between users. Hundreds of millions of people around the world have access to the Internet and all the information that it provides. New uses for the Internet are constantly being created and expanded.

People are using IP-based networks, such as Local Area Networks (LANs), Wide Area Networks (WANs), and the Internet, as a medium for exchanging personal communications. Some examples include VoIP, Chat and IM. VoIP allows the transmission of voice data while Chat and IM allow the transmission of text data.

These communication protocols allow data to be routed over any IP-based network. The data flows over general-purpose packet-switched networks and is very efficient since each message only uses the hardware resources it requires. Traditional telephone methods use a circuit-switching technology that requires a dedicated communication pathway reserved for the entire duration of the call.

The hardware requirements for sending a VoIP message or IM are fairly minimal. A caller may send a message from a terminal adapter, such as an IP phone, with Internet access. A slightly more complicated set-up allows a caller to place a call from a Plain Old Telephone Service (POTS), typically carried over the Public Switched Telephone Network (PSTN), which gains access to the Internet via a message server, such as a VoIP server or an IM server. The receiver of a VoIP message or IM will need either a terminal adapter with Internet access or POTS that may be reached by a message server.

Long distance telephone charges may be greatly reduced through the use of VoIP or IM since the caller and receiver are typically not charged additional fees based on the distance the call traveled over the IP-based network. This makes VoIP and IM extremely popular with companies and individuals looking to reduce their long distance telephone charges.

Currently, there are few problems with SPAM (unsolicited commercial advertisements) being transmitted as VoIP or IM messages. However, using the mail, email, and traditional telephones as models, the amount of SPAM over Internet Telephony (SPIT) in the future is likely to increase as the popularity of VoIP and IM continue to increase. Methods of reducing the anticipated rise in SPIT before it becomes a problem are therefore desirable.

### SUMMARY OF THE INVENTION

The present invention provides improved methods for authenticating a caller initiating a communication session. In preferred embodiments, the communication session may follow either the VoIP protocol for transmitting voice data or the IM protocol for transmitting text data. A header block may be created during the process of initiating a communication session. In a preferred embodiment, the header block conforms to SIP. The header block may include a plurality of fields, such as a field for the identity of the caller, the telephone number, domain name or IP address of the caller, and a field for the telephone number, domain name or IP address of the receiver.

A digital signature may be created using the caller's private key. One or more fields, or combination of fields, in the header block may be signed to create the digital signature. Alternatively, a message digest may be created by a hash of one or more fields in the header block and signed to create the digital signature. The digital signature may be inserted into one of the fields in the header block. The caller's terminal adapter or message server may then transmit the header block over an IP-based network to initiate a communication session.

A receiver's terminal adapter or message server may receive the header block from the IP-based network. A public key corresponding to the private key used by the caller may be obtained, for example, through a distributed database such as the domain name system (DNS) and used to decrypt the digital signature. The decrypted digital signature may be compared to the fields in the header block. Alternatively, a second message digest may be created from the same fields used to create the first message digest and compared to the decrypted digital signature.

The communication session may be accepted or terminated based on the validity of the digital signature. If the communication session is accepted, further filtering and automated routing of the communication session by the terminal adapter or message server may still be performed.

Additional advantages and aspects of the present invention will become apparent in the following detailed description of the invention and the claims.

### BRIEF DESCRIPTION OF THE DRAWINGS

FIG. 1 is a block diagram illustrating the relationships of elements and the communication path ways in an example embodiment of the invention.

FIG. 2 is a flowchart illustrating an exemplary method of practicing the invention.

FIG. 3 is a flowchart illustrating another exemplary method of practicing the invention.

FIG. 4 is a flowchart illustrating another exemplary method of practicing the invention.

FIG. 5 is a flowchart illustrating another exemplary method of practicing the invention.

### DETAILED DESCRIPTION OF THE PREFERRED EMBODIMENTS

The present invention will now be discussed in detail with regard to the attached drawing figures that were briefly described above. In the following description, numerous specific details are set forth illustrating Applicants' best mode for practicing the invention and for enabling one of ordinary skill in the art to make and use the invention. It will be obvious, however, to one skilled in the art that the present invention may be practiced without many of these specific details. In other instances, well-known machines and process steps have not been described in particular detail in order to avoid unnecessarily obscuring the present invention. Unless otherwise indicated, like parts and processes are referred to with like reference numerals.

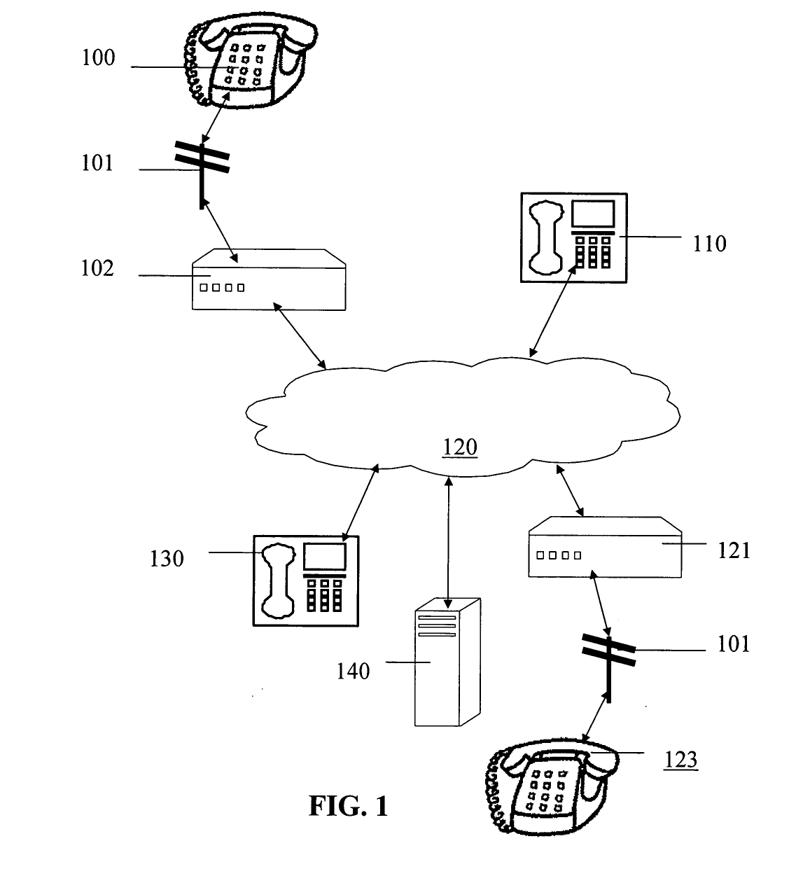

Exemplary equipment and communication pathways for practicing the invention are illustrated in FIG. 1. The invention permits a caller initiating a communication session to be authenticated via the caller's digitial signature stored in a header block. The digital signature preferably conforms to the Public Key Infrastructure (PKI) protocol. The authentication process gives the receiver a method to block, screen or automatically route calls as desired. In addition, once the identity of the caller has been authenticated/determined, other filtering techniques, e.g. white and black lists, may be used as additional layers of filtering the call.

The Plain Old Telephone Service (POTS) 100, which is the standard telephone service used by most homes, may be used by a caller to initiate a communication session. A call from the POTS 100 is commonly carried over the Public Switched Telephone Network (PSTN) 101. The PSTN 101 is a publicly available international dial-up telephone network typically based on copper wires carrying analog voice data.

While the PSTN 101 is very well established, newer digital technologies, such as Integrated Services Digital Network (ISDN) and Fiber Distributed Data Interface (FDDI) are making headway and may also be used.

The PSTN 101 may connect to a caller's message server 102. The message server 102 may be, as non-limiting examples, a VoIP server or an IM server. The caller will typically need to purchase an account with the message server 102. The caller's message server 102 may alter the format of the call so that it is suitable to be carried over an IP-based network 120, such as a LAN, WAN or the Internet.

A caller may also initiate a communication session by using a terminal adapter 110 such as an Internet protocol telephone (IP telephone) or computer with appropriate software. The terminal adapter 110 may place the call in a format suitable to be carried over an IP-based network 120. The terminal adapter 110 may be connected to the IP-based network 120, such as by a T1 line, cable or wireless connection.

SIP is a signaling protocol that may be used to establish a communication session over the IP-based network 120. While other protocols may be used to establish a communication session, SIP is very popular due to its flexibility and ease of use and its ability to work with many other Internet protocols.

The IP-based network 120 may connect the call to a receiver's terminal adapter 130 or message server 121 which may then be carried over the PSTN 101 to a POTS 123. In preferred embodiments, the message server 121 may be a VoIP or IM server. From this description it may be appreciated that a communication session may be initiated from a caller's terminal adapter 110 or message server over an IP-based network 120 to a receiver's terminal adapter 130 or message server 121.

The identity of the caller is preferably verified prior to the caller initiating a communication session by a trusted third party. The authentication process may be as simple or as rigorous as desired. Obviously, the more rigorous the authentication process, the greater the confidence that can be placed in the identity of the caller, but the greater the burden in performing the authentication process.

In a preferred embodiment, the trusted third party is a Registrar of domain names. The Registrar may limit access to a registrant's DNS record to only the registrant (who may also be the caller). The registrant may place his/her public key in a distributed database 140 record, such as the registrant's DNS record. Since only the registrant should have access to the registrant's DNS record, receivers may read the registrant's DNS record and have some level of assurance that the public key found there is the public key of the registrant. The receiver may compare the identity of the registrant as stated in the DNS record with the identity of the caller as stated in the header block in order to authenticate the caller if the digital signature is verified.

The caller may retain control over the private key associated with the caller's public key. The private key may be stored in the caller's terminal adapter 110 and/or the caller's message server 102. PKI technology may be used to create and use the public and private keys to encrypt and decrypt the digital signatures.

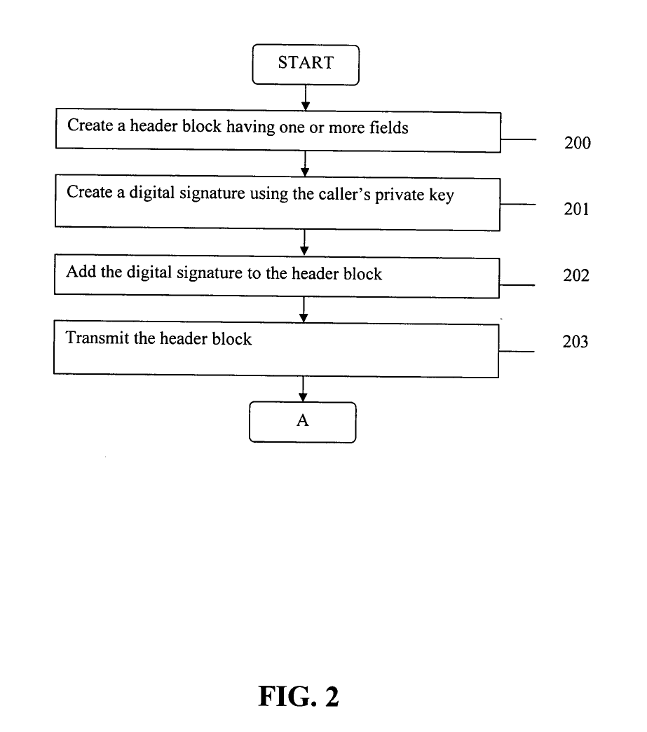

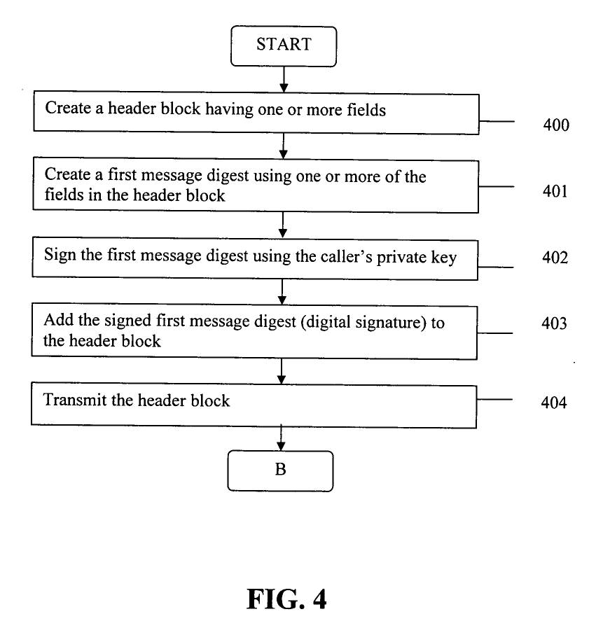

Two different embodiments for practicing the invention are illustrated in FIG. 2 and FIG. 4. A caller may initiate a communication session from a POTS 100 or from a terminal adapter 10. A communication session initiated on POTS 100 may be limited to selecting only a receiver's phone number, while a communication session initiated on a terminal adapter 110 may use the receiver's phone number, IP address or an assignable virtual address. An example of a SIP assignable virtual address is sip:voicemail@johndoe.name. A SIP registration may be used to assign a telephone number or an IP address to the assignable virtual address.

The caller's terminal adapter 110 or message server 102 may create a header block used to establish a communication session. The header block may include a plurality of fields, such as a “from” field (identifies the caller) and a “to” field (identifies the receiver) (steps 200 and 400). Other fields may also be included in the header block as desired and as required by the various protocols used to initiate the communication session over the IP-based network 120.

In order to authenticate the caller listed in the “from” field as the sender of the header block, one or more fields in the header block may be signed using the caller's private key (step 201). In another embodiment, a hash may be used to create a first message digest using one or more of the fields in the header block (step 401). The first message digest may then be signed using the caller's private key (step 402). The digital signature created from the fields in the header block or from the message digest may be added to the header block, preferably using a field in the header block reserved for this purpose (steps 202 and 403). The signed header block may then be transmitted to the receiver's terminal adapter 130 or message server 121 (steps 203 and 404).

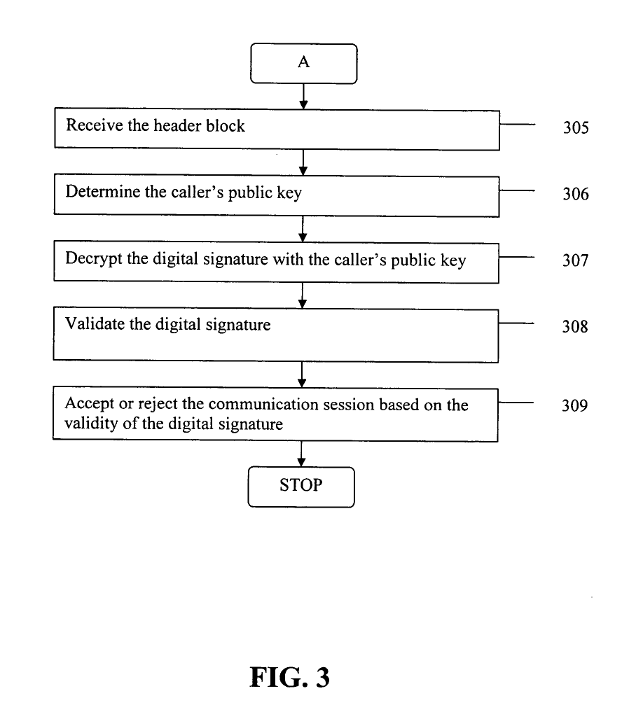

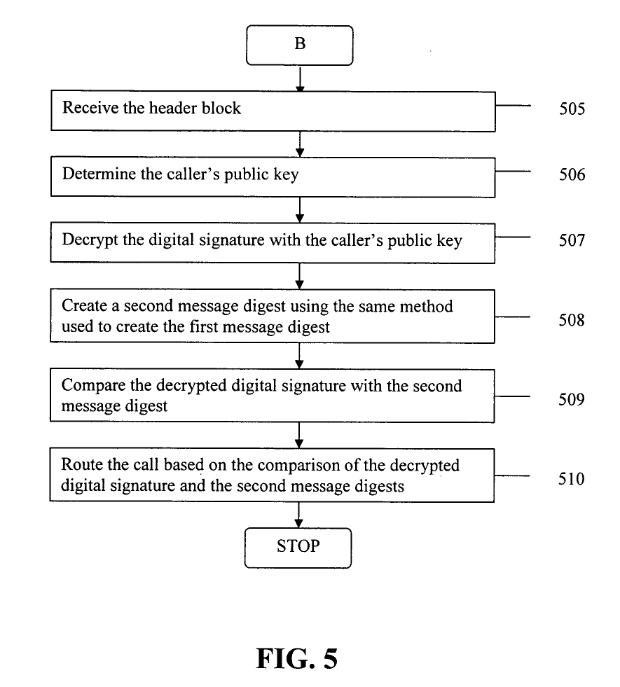

Another two embodiments for practicing the invention are illustrated in FIG. 3 and FIG. 5. The receiver's terminal adapter 130 or message server 121 may receive the signed header block (steps 305 and 505) and determine the caller's public key. The caller's public key may be made accessible by a distributed database. In a preferred embodiment, the caller's public key is stored in a caller's (registrant's) DNS record. The caller's public key may also be read from internal memory if the receiver has determined and saved the caller's public key in the past (steps 306 and 506).

The digital signature in the header block may be decrypted using the caller's public key (steps 307 and 507). Conventional methods may be used to authenticate the validity of the digital signature. If the digital signature was made from the first message digest, a second message digest may be calculated using the same fields and methods used to create the first message digest (step 508). The decrypted digital signature may be compared with the fields in the header block used to create the digital signature (step 308) or with the newly created second message digest (step 509).

The VoIP message or IM (which may follow the header block if a communication session was established) may be routed based on the analysis of the header block (steps 309 and 510). For example, if there was no digital signature or the digital signature was not validated, thereby not authenticating the identity of the caller, the communication session may be rejected or the VoIP message or IM may be routed to a storage area that may be reviewed by the receiver at a later time. The storage area may be reserved for storing undesired communications, such as unsolicited commercial advertisements. The filtering and routing of messages may be automatically performed by the receiver's terminal adapter 130 or message server 121 without disturbing the receiver.

Additional filtering and routing of the communication may take place even if the communication session has been accepted and/or the caller has been authenticated via the caller's digital signature. Information in the header block, such as the caller's identity, telephone number, IP address, etc. may be checked against a white list and if information in the header block is found on the white list the call may be allowed to proceed. The white list may be created by the receiver entering different caller's identities into the receiver's terminal adapter 130 or message server 121 that they always wish to receive communications from or by pressing a button once a call has been received from a caller that the receiver wishes to place on the white list.

Information in the header block, such as the caller's identity, telephone number, IP address, etc. may also be checked against a black list and if information in the header block is found on the black list the call may be rejected or the communication session may be directed to a bulk storage area, such as the receiver's voice or text mail box. The black list may be created by the receiver entering information related to unwanted callers or by pressing a button once a call has been received from a caller that the receiver wishes to place on the black list. In addition, lists may be made available from different services on the Internet that contain known producers of SPIT. These general black lists may be appended to the receiver's personal black list and stored in the receiver's terminal adapter 130 or message server 121.

Multiple variations and modification to the disclosed embodiments will occur, to the extent not mutually exclusive, to those skilled in the art upon consideration of the foregoing description. For example, not all steps are required to be performed in the order disclosed and in fact some steps may be skipped altogether in certain embodiments of the invention. Also, VoIP and IM were specifically mentioned as preferred protocols for transmitting data, however any protocol that uses a header block to initiate a communication session may also be used with the invention. In addition, SIP was specifically mentioned as the preferred protocol for creating a header lock used to initiate a communication session, however any protocol that uses a header block to initiate a communication session may also be used. Such variations and modifications, however, fall well within the scope of the present invention as set forth in the following claims.

What is claimed is:

1. A method for authenticating a caller initiating a communication session, comprising the steps of:
a) a message server creating a header block, wherein the header block is used to initiate a communication session over an IP-based network;
b) the message server creating a digital signature using a private key of the caller;
c) the message server adding the digital signature to the header block; and
d) the message server transmitting the header block over the IP-based network.

2. The method of claim 1, further comprising the step of:
e) a registrant storing a public key associated with the private key of the caller in a DNS record of the registrant.

3. The method of claim 1, wherein at least one field in the header block is used to create the digital signature.

4. The method of claim 1, wherein a message digest is created by a hash of at least one field in the header block and used to create the digital signature.

5. A method for authenticating a caller initiating a communication session, comprising the steps of:
a) a message server receiving a header block over an IP-based network;
b) the message server obtaining a public key corresponding to a private key assigned to a caller;
c) the message server decrypting a digital signature within the header block using the public key;
d) the message server validating the digital signature; and
e) the message server accepting or rejecting the communication session based on the validity of the digital signature.

6. The method of claim 5, wherein the public key was obtained from a DNS record.

7. The method of claim 5, wherein the message receiver is a VoIP server.

8. The method of claim 5, wherein the message receiver is a IM server.

9. The method of claim 5, further comprising the step of:
f) if the message server accepted the communication session, routing the communication session based on the validity of the digital signature.

10. The method of claim 5, further comprising the step of:
f) if the message server accepted the communication session, routing the communication session based on whether the caller is on a white list.

11. The method of claim 5, further comprising the step of:
f) if the message server accepted the communication session, routing the communication based on whether the caller is on a black list.

12. A method for authenticating a caller initiating a communication session, comprising the steps of:
a) a first message server creating a header block used to initiate a communication session;
b) the first message server creating a digital signature using a private key assigned to a caller;
c) the first message server adding the digital signature to the header block;
d) the first message server transmitting the header block over an IP-based network;
e) a second message server receiving the header block over an IP-based network;
f) the second message server obtaining a public key corresponding to the private key assigned to the caller;
g) the second message server decrypting the digital signature with the public key;
h) the second message server verifying the validity of the decrypted digital signature; and
i) the second message server accepting or rejecting the communication session.

13. The method of claim 12, further comprising the step of:
j) a registrant storing a public key associated with the private key of the caller in a DNS record accessible by the registrant.

14. The method of claim 12, wherein the second message server accepts the communication session if the digital signature was verified.

15. The method of claim 12, wherein the second message server rejects the communication session if the digital signature was not verified.

16. The method of claim 12, wherein the public key was obtained from a DNS record.

17. The method of claim 12, further comprising the step of:
j) if the communication session has been accepted, routing the call based on information in the header block.

18. The method of claim 12, further comprising the step of:
j) if the communication session has been accepted, routing the call based on comparing information in the header block with information on a white list.

19. The method of claim 12, further comprising the step of:
j) if the communication session has been accepted, routing the call based on comparing information in the header block with information on a black list.

20. The method of claim 12, wherein the communication session is accepted based on comparing information in the header block with information in a white list.

21. The method of claim 12, wherein the communication session is rejected based on comparing information in the header block with information in a black list.

22. A method for authenticating a caller initiating a communication session, comprising the steps of:
a) a message server creating a header block used to initiate a communication session;
b) the message server creating a digital signature using a private key assigned to a caller;
c) the message server adding the digital signature to the header block;
d) the message server transmitting the header block over an IP-based network;
e) a terminal adapter receiving the header block over an IP-based network;
f) the terminal adapter obtaining a public key corresponding to the private key assigned to the caller;
g) the terminal adapter decrypting the digital signature with the public key;
h) the terminal adapter verifying the validity of the decrypted digital signature; and
i) the terminal adapter accepting or rejecting the communication session.

23. The method of claim 22, further comprising the step of:
j) a registrant storing a public key associated with the private key of the caller in a DNS record accessible by the registrant.

24. The method of claim 22, wherein the terminal adapter accepts the communication session if the digital signature was verified.

25. The method of claim 22, wherein the terminal adapter rejects the communication session if the digital signature was not verified.

26. The method of claim 22, wherein the public key was obtained from a DNS record.

27. The method of claim 22, further comprising the step of:
j) if the communication session has been accepted, routing the call based on information in the header block.

28. The method of claim 22, further comprising the step of:
j) if the communication session has been accepted, routing the call based on comparing information in the header block with information on a white list.

29. The method of claim 22, further comprising the step of:
j) if the communication session has been accepted, routing the call based on comparing information in the header block with information on a black list.

30. The method of claim 22, wherein the communication session is accepted based on comparing information in the header block with information in a white list.

31. The method of claim 22, wherein the communication session is rejected based on comparing information in the header block with information in a black list.
